(19) United States
(12) Patent Application Publication
(10) Pub. No.: US 2022/0114685 A1
(43) Pub. Date: Apr. 14, 2022

(54) METHOD AND SYSTEM OF EVALUATING ATTRIBUTION OF PATENT CONTENT USING CLASSIFICATION INFORMATION

(71) Applicant: KOREA INVENTION PROMOTION ASSOCIATION, Seoul (KR)

(72) Inventors: Jung Ae KWAK, Seoul (KR); Sang Youp SONG, Gwacheon (KR); In Jae PARK, Seoul (KR)

(21) Appl. No.: 17/560,120

(22) Filed: Dec. 22, 2021

Related U.S. Application Data
(63) Continuation-in-part of application No. 16/191,163, filed on Nov. 14, 2018.

(30) Foreign Application Priority Data
Nov. 27, 2017 (KR) 10-2017-0159625

(51) Int. Cl. G06Q 50/18; G06N 3/08

(52) U.S. Cl. CPC G06Q 50/184; G06N 3/08

(57) ABSTRACT

According to an illustrative embodiment of the present disclosure, a method of evaluating an attribute of a patent content includes the steps of: receiving class information and an input score for a target patent content to be evaluated; selecting at least some evaluation factors among the evaluation factors included in the predetermined evaluation factor set, based on the class information; calculating an attribute evaluation feature value of the target patent content using the input score for each of the evaluation factors and evaluation factor weights which are determined in advance to be different depending on the class information; and providing a text or an image according to the attribute evaluation feature value of the target patent content to a user interface of a computing apparatus.

### CROSS REFERENCE TO RELATED APPLICATIONS

This U.S. patent application is a continuation-in-part of U.S. application Ser. No. 16/191,163 filed on Nov. 14, 2018, and claims priority from KR patent application Ser. No. 10-.2017-0159625 filed Nov. 27, 2017, now KR Pat. No. 10-1995011. The disclosures of the prior applications are considered part of (and are hereby incorporated by reference in) the disclosure of this application.

### BACKGROUND

The present disclosure relates to a system and a method of evaluating an attribution of a patent content using class information and also relates to a method for evaluating patents using a structural equation model, a system for performing the method, and a computer readable storage medium in which the method is stored, and more particularly, to a method for evaluating a grade of a patent by statistically processing a plurality of patent evaluation indexes using a structural equation model, a system for performing the method, and a computer readable storage medium in which a computer program executing the method is stored.

In the knowledge-based and global economic societies, intangible intellectual properties such as patents, trademarks, designs, and copyrightable works are emerging as core elements of national and corporate competitiveness rather than tangible assets such as lands and capitals. In particular, the patent is a representative intellectual property of intangible assets and importantly used as an objective measure to measure a technology level and innovation competence of individuals, companies, and countries.

Since the patent gives an owner to exercise their exclusive rights for the invention for a certain period of time with respect to the new technical direction, the patent is very important for the company's profitability and stable business operations.

When the patent is registered through examination after filing an application, an exclusive status is maintained for 20 years from the filing date. However, patent maintenance fee needs to be paid to maintain the exclusive status.

Therefore, companies with a large number of held patents are burdened with patent maintenance fees so that some companies abandon the patent rights before 20 years from the filing date. In this case, in order to select patents to be abandoned, evaluation for the patents should precede. Technical valuation of the patents is divided into a market approach, a profit approach, and a cost approach.

The market approach is a method for calculating a relative value through comparison and analysis based on a value of the same or similar technique as a target technology traded in an active market. The profit approach is a method for converting economic benefits to be generated by technical commercialization during an economic life of the target technology into a present value by applying an appropriate discount rate. Finally, the cost approach is a method for calculating a value of the technology based on costs invested to develop the target technology or estimating a cost to develop or purchase a technology having the same economic effect and profit based on an alternative economic principle.

In the meantime, according to the technology valuation, experts survey and analyze data of the technology and market oligopoly by dividing technicality, rightness, marketability, and business feasibility of a target technology to suggest a subjective evaluation opinion and a final value is calculated in accordance with the collected opinions of the experts. Therefore, it takes a quite long time and a lot of money.

In order to save the time and costs for the technology valuation, the companies select patents to be abandoned by subjective judgements of a person in charge of the patent, instead of the experts, in many cases.

As a solution for this, a service which systematically valuates the patent is being introduced.

However, when an evaluation model is designed based on only some fragmentary factors or an evaluation model is designed using one multiple regression model, a reliability of the evaluation results is often questionable.

In the meantime, the background art of the present disclosure is disclosed in Korean Unexamined Patent Application Publication No. 10-2011-0068278.

Recently, in accordance with the continuous development of technologies, new technologies such as artificial intelligence technology and convergence technology are being developed. In this situation, when the attribute of the patent is evaluated by technology classification according to the classical method, there are limitations in that the technology classification itself is inaccurate and it is difficult to evaluate a convergence technology having various technical attributes. Specifically, patent contents valuable as technical data and as rights data are data which are continuously accumulated from the past. When it is considered that the patent contents have been accumulated for decades and will be accumulating at a faster rate in the future need to be repeatedly evaluated, it is difficult to evaluate patent contents which are cumulative data with a processing speed according to the existing technology.

### SUMMARY

In consideration of the limitations of the related art as described above, an object of the present disclosure is to provide an automated method and system of evaluating an attribute of patent contents using technology class information. Further, another object of the present disclosure is to provide a method and a system of evaluating an attribute of a target patent document using an artificial neural network having a connection weight which is determined to be different depending on the technology classification and an evaluation element.

In order to achieve the above-described object, according to an aspect of the present disclosure, a computing apparatus includes at least one processor; and at least one non-transitory computer-readable memory storing executable instructions thereon, wherein the at least one processor programmed by the executable instructions performs operations including: receiving class information for a class to which the target patent contents with an attribute to be evaluated pertains and an input score according to each of evaluation factors included in a predetermined evaluation factor set to evaluate the attribute of the patent contents; selecting at least some evaluation factors among the evaluation factors included in the predetermined evaluation factor set, based on the class information; calculating an attribute evaluation feature value of the target patent content using the input score for each of the evaluation factors and weights which are determined in advance to be different depending on the class information and the evaluation factor; and providing a text or an image according to the attribute evaluation feature value of the target patent content to an user interface of the computing apparatus.

According to the present disclosure, the calculating of the attribute evaluation feature value includes inputting the input score to an artificial neural network which is trained in advance to be differently determined according to the class information and the evaluation factor and calculating an attribute evaluation feature value representing the attribute of the target patent content by the artificial neural network.

The selecting of at least some of evaluation factors includes selecting at least some evaluation factors among the plurality of evaluation factors included in the predetermined evaluation factor set, based on a first reference score stored in a training data storage, and the first reference score is information related to content validity of each evaluation factor for evaluating the attribute of the patent content and is received from a plurality of external computing apparatuses which is connected via a network.

According to the present disclosure, the artificial neural network includes a plurality of nodes and connection weights which connect the nodes and some connection weights among the connection weights are implemented to be determined according to the first reference score.

According to the present disclosure, the computing device includes: a communication interface for communication with the plurality of external computing apparatuses; and a controller which controls values for some connection weights among the connection weights, in consideration of the first reference score.

In the selecting of at least some evaluation factors among the evaluation factors included in the predetermined evaluation factor set, based on the class information, one or more reference scores selected from a group consisting of the first reference score, a second reference score which represents a similarity between reference scores acquired for each evaluation factor at different timings from the same computing apparatus and is calculated by the processor, and third reference scores which represent a convergence attribute of the first reference scores acquired for each evaluation factor from the plurality of computing apparatus and are calculated by the processor are compared with a predetermined reference value and at least some evaluation factors among the plurality of evaluation factors included in the predetermined evaluation factor set are selected according to a comparison result.

Here, the second reference score represents a similarity between reference scores acquired for each evaluation factor, from the same computing apparatus at different timings. The third reference score is a score representing a convergence attribute of the first reference scores acquired for each evaluation factor from the plurality of computing apparatus.

Desirably, the first reference score is related to the content validity of each evaluation factor and includes already acquired content validity ratio (CVR) information. Further, the third reference score includes an agreement degree or a convergence degree related to the convergence attribute for each evaluation factor. further, the evaluation factor weight is an impact index representing an impact for each evaluation factor to calculate the attribute evaluation feature value and the impact index is a relative impact index representing a relative impact as compared with an impact of one reference evaluation factor among the selected evaluation factors.

According to the present disclosure, the controller further includes a first controller, a second controller, and a gate circuit. The first controller generates a first control value depending on whether the first reference score calculated for each evaluation factor satisfies a predetermined criterion and transmits the first control value to the artificial neural network. The gate circuit performs a logical operation on whether the second reference score calculated for each evaluation factor satisfies another predetermined criterion or whether the third reference score satisfies another predetermined criterion. The second controller generates a second control value according to the logical operation result of the gate circuit to transmit the second control value to the artificial neural network.

In order to achieve another object of the present disclosure, according to another aspect, a method of evaluating an attribute of a patent content which is performed by at least one processor includes: receiving class information for the class to which the target patent contents with an attribute to be evaluated pertains and an input score according to each of evaluation factors included in a predetermined evaluation factor set so as to evaluate the attribute of the patent contents, selecting at least some evaluation factors among the evaluation factors included in the predetermined evaluation factor set, based on the class information, calculating an attribute evaluation feature value of the target patent content using input scores for each of the evaluation factors and evaluation factor weights which are determined in advance to be different depending on the class information and the evaluation factor, and providing a text or an image according to the attribute evaluation feature value of the target patent content to an user interface of a computing apparatus.

When a time-sequential deviation between attribute evaluation facture values of the patent contents belonging to the same class information satisfies a predetermined criterion, the artificial neural network further preforms the learning to update the connection weight. At this time, when the attribute evaluation feature value of the target patent content is calculated, the connection weight is acquired through an updated artificial neural network.

In order to achieve still another object of the present disclosure, the present disclosure provides a computer readable recording medium in which a program allowing a computer to perform the method of evaluating an attribute of a patent content.

According to an aspect of the present disclosure, a patent evaluating method using a structure equation includes the steps of: receiving an evaluation for an importance of a plurality of evaluation factors required to build an evaluation model for each of a plurality of predetermined evaluation indexes, from a plurality of experts, to evaluate a registered patent, verifying the evaluations of the plurality of experts for the importance of the individual evaluation factors, setting the verified evaluation factors as final evaluation factors, determining impact indexes of the set evaluation factors required to build an evaluation model for each evaluation index, using structural equation model analysis, generating an evaluation model for each evaluation index using the set evaluation factor, the set impact index, and a structural equation, obtaining patent information, and generating an evaluation result using the generated evaluation model and the obtained patent information for the patent to be evaluated.

According to another aspect of the present disclosure, a patent evaluating system using a structure equation includes: at least one processor; and at least one memory, the at least one memory and the at least one processor store and execute commands which allow the system to perform operations and the operations includes receiving an evaluation for an importance of a plurality of evaluation factors required to build an evaluation model for each of a plurality of predetermined evaluation indexes, from a plurality of experts, to evaluate a registered patent, verifying the evaluations of the plurality of experts for the importance of the individual evaluation factors, setting the verified evaluation factors as final evaluation factors, determining impact indexes of the set evaluation factors required to build an evaluation model for each evaluation index, using structural equation model analysis, and generating an evaluation model for each evaluation index using the set evaluation factor, the set impact index, and a structural equation.

According to still another aspect of the present disclosure, a patent evaluation model building method using a structure equation includes the steps of: receiving an evaluation for an importance of a plurality of evaluation factors required to build an evaluation model for each of a plurality of predetermined evaluation indexes, from a plurality of experts, to evaluate a registered patent, verifying the evaluations of the plurality of experts for the importance of the individual evaluation factors, setting the verified evaluation factors as final evaluation factors, determining impact indexes of the set evaluation factors required to build an evaluation model for each evaluation index, using structural equation model analysis, and generating an evaluation model for each evaluation index using the set evaluation factor, the set impact index, and a structural equation.

According to the present disclosure, the patent attribute is evaluated by focusing on the technology class information to which the patent content belongs, and the evaluation factor selected according to the technology class information to enable automated patent attribute evaluation which is differentiated for every technical field to which the patent content pertains. Specifically, an attribute evaluation feature value is calculated by a simplified operation using an input score for some evaluation factors selected according to the technology classification and a predetermined connection weight so that the processing burden for repetitive and cumulative patent content data may be reduced.

Further, according to the present disclosure, a range of an operation weight is selectively limited according to the technology classification and an artificial neural network structure having an operation weight in a selectively limited range is employed which is advantageous in that the learning for every technology attribute is performed in a limited range and the problem of vanishing gradient which may occur in the existing artificial neural network or the problem of the increased computational amount for the learning may be minimized or eliminated.

According to the present disclosure, a large amount of patents is quickly evaluated at a low cost with an objective evaluation criterion to contribute to make a decision on whether to maintain annual registration of a patent right. Further, evaluation information corresponding to evaluation indexes of rightness, technicality, and usability for one patent is generated to calculate patent evaluation information for every evaluation index. Further, the patent evaluation information is generated for every technical field so that patent competitiveness of the patents in the corresponding technical field is analyzed to check statuses of the patents in the corresponding technical field and help to make a decision to maintain/manage the patents, and analyze companies which lead the technical field.

### BRIEF DESCRIPTION OF THE DRAWINGS

FIG. 1 is a flowchart of a patent evaluating method using a structural equation model according to an illustrative embodiment of the present disclosure;

FIG. 2 is a detailed flowchart of a step (a) of the present disclosure;

FIG. 3 is a view illustrating various evaluation models;

FIG. 4 is a diagram of a patent evaluating system using a structural equation model according to an illustrative embodiment of the present disclosure;

FIG. 5 is an illustrative view illustrating a schematic configuration of a patent evaluating system using a structural equation model according to an illustrative embodiment of the present disclosure;

FIG. 6 is a conceptual view illustrating a system including a computing apparatus which evaluates an attribute of patent content according to another illustrative embodiment of the present disclosure;

FIG. 7 is a detailed block diagram of a processor 1400, a controller 1300, and an artificial neural network 1600 illustrated in FIG. 6; and

FIG. 8 is a flowchart illustrating a patent content attribute evaluating method according to still another illustrative embodiment of the present disclosure.

### DETAILED DESCRIPTION

According to one embodiment, one or more evaluation models are generated by using structural equation may vary depending on a technical field of the patent or an evaluation index such as a rightness index, a technicality index, and a usability index. According to one embodiment, an evaluation survey result for the importance of the individual evaluation factors performed by patent experts in the technical field of the patent to be evaluated may be used for the evaluation for an importance of each of a plurality of evaluation factors received from the experts.

According to another embodiment, the importance of the individual evaluation factors includes a degree of consensus and convergence degree verifying step of verifying a degree of consensus and a convergence degree for every evaluation factor on the evaluation survey result.
According to one embodiment, the step of verifying the evaluations of the plurality of experts for the importance of the individual evaluation factors includes the steps of verifying a content validity for every evaluation factor on the evaluation survey result for the importance of the individual evaluation factors and verifying reliability for every evaluation factor for the evaluation survey result on which the content validity verifying step is performed.

A mutual causal relationship between several variables which affect a dependent variable included in the evaluation model is analyzed during generation of the evaluation model.

Hereinafter, the present invention will be described more fully hereinafter with reference to the accompanying drawings, in which illustrative embodiments of the invention are shown. However, the present invention can be realized in various different forms, and is not limited to the illustrative embodiments described herein. Accordingly, the drawings and description are to be regarded as illustrative in nature and not restrictive. Like reference numerals designate like elements throughout the specification.

Terms including an ordinary number, such as first and second, are used for describing various constituent elements, but the constituent elements are not limited by the terms. The above terms are used only to discriminate one component from the other component. For example, without departing from the scope of the present invention, a first component may be referred to as a second component, and similarly, a second component may be referred to as a first component. Terms used in the present application are used only to describe specific illustrative embodiments, and are not intended to limit the present invention. A singular form may include a plural form if there is no clearly opposite meaning in the context.

In addition, unless explicitly described to the contrary, the word “comprise” and variations such as “comprises” or “comprising”, will be understood to imply the inclusion of stated elements but not the exclusion of any other elements. Terms used throughout the specification, “˜step of ˜ing” or “step of˜” do not mean “step for˜”.

Terminologies used in the specification are selected from general terminologies which are currently and widely used as much as possible while considering a function in the present invention, but the terminologies may vary in accordance with the intention of those skilled in the art, custom, or appearance of new technology. Further, in particular cases, the terminologies are arbitrarily selected by an applicant and in this case, the meaning thereof may be described in a corresponding section of the description of the invention. Therefore, the terminology used in the specification is analyzed based on a substantial meaning of the terminology and the specification rather than a simple title of the terminology.

### 1. Structural Equation Modeling

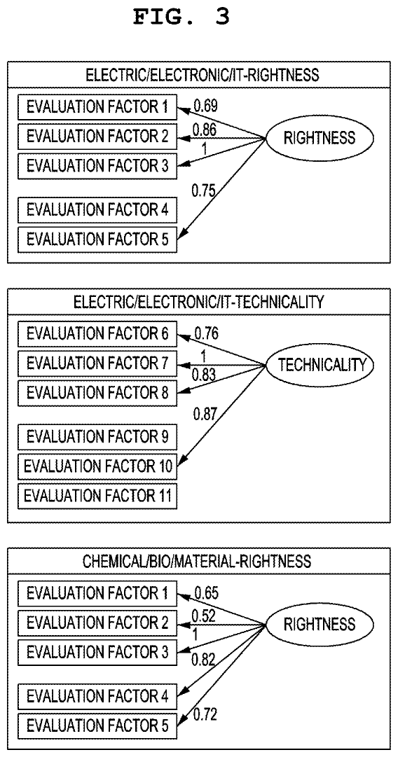

In the present disclosure, a structural equation modeling technique is applied to evaluate patents. The structural equation modeling (SEM) is characterized to find and analyzes mutual causal relationship between several variables which affect dependent variables to process factor analysis (impact analysis) and path analysis (procedure of patent evaluation). The most important issue of the statistical approach is to construct a model which sufficiently approximates true principles of uncertain phenomena to know or probabilistically expresses the true principles. When a set of certain measurements for a phenomenon to know is a reaction variable or a random variable Y, the unknown phenomenon for an inquiry is expressed by a probability function of f(Y|θ) and θ is a set of parameters which are parameters of the random variable. Specifically, suppose that a researcher observes several types of variables, defines constructs using the variables, and then studies how these constructs are associated with each other. In this case, the researcher may construct various theoretical models, performs quantitative hypothesis testing for the suitability of each theoretical model, and find a model which is the most appropriate for the observed data and this process is referred to as a structural equation or a structural equation modeling (SEM). The structural equation may be a variable which is directly observed or is not measured and may be divided into a latent variable which is a latent factor of measurement variables and an observed variable which is directly measured. An exogenous (latent) variable is an independent latent variable and affects other latent variables. An endogenous (latent) variable is a dependent variable and is directly or indirectly affected. The structural equation is an analysis method in which three analysis techniques of regression analysis, path analysis (PA), and confirmatory factor analysis (CFA) are combined. In the present disclosure, as illustrated in FIG. 3, the path analysis which analyzes an impact index of each evaluation factor and connects the evaluation factors is applied.

### 2. Patent Evaluating Method Using Structural Equation According to an Illustrative Embodiment of the Present Disclosure

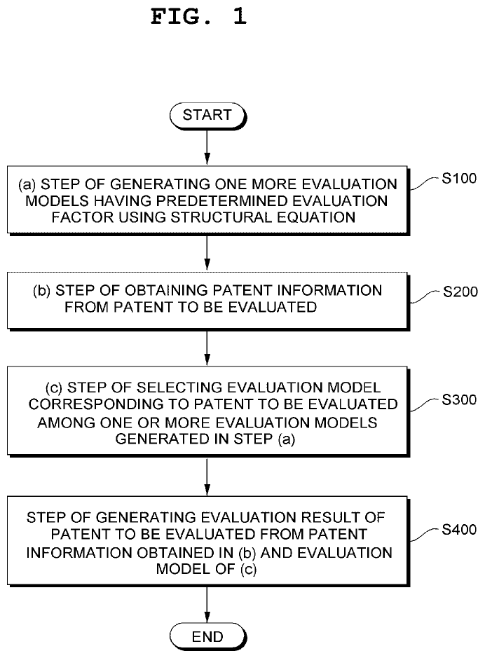

FIG. 1 is a flowchart of a patent evaluating method using a structural equation according to an illustrative embodiment of the present disclosure.

Hereinafter, a patent evaluating method using a structural equation according to an illustrative embodiment of the present disclosure will be described with reference to FIG. 1.

The patent evaluating method using a structural equation according to an illustrative embodiment of the present disclosure includes (a) a step S100 of generating one or more evaluation models having a predetermined evaluation factor using a structural equation, (b) a step S200 of obtaining patent information from a patent to be evaluated, (c) a step S300 of selecting an evaluation model corresponding to the patent to be evaluated among one or more evaluation models generated in step S100, and (d) a step S400 of generating an evaluation result of the patent to be evaluated based on the patent information obtained in step S200 and the evaluation model selected in step S300.

In the meantime, in the step (b) S200, the patent information obtained from the patent to be evaluated refers to relevant information generated in association with the patent from the time of occurrence to the expiration of one patent, including an application form including a patent specification and drawings, an examination history, progress information (administrative information) after registration of rights. The patent information may include a technical field of the patent, application information, examination information, registration information, patent right information, patent trial information, and litigation information.

More specifically, the application information may include a number of independent claims, a length of an independent claim, a number of dependent claims, an average length of the dependent claim, a number of drawings, a length of a description of the invention, divisional application, a number of claims of priority, and a number of overseas patent families.

Further, the examination information may include a number of IPCs, early publication, accelerated examination, re-examination, a number of presented opinions, a number of provision of information, a total number of citation, a difference between citation and filing date, a number of papers/foreign patents among prior documents, a number of papers/foreign patents of cited documents. The registration information may include a number of annual registrations.

The patent right information may include a number of inventors, whether to determine registration for an extension of patent term, a number of licensees, a number of changed holders of right, a number of established pledge rights of a financial company.

In the meantime, the trial information may include a number of trials on invalidity, a number of appeals against decision of rejection, a number of quotation of trial to positive confirmation on the scope of rights, a number of rejection/withdraw/dismissal of trials to positive confirmation on the scope of rights, a number of rejection of trial to negative confirmation on the scope of rights, a number of quotation/withdraw/dismissal of trials to negative confirmation on the scope of rights, and a number of correction trials.

2-(a) Step of Generating One or More Evaluation Models Having Predetermined Evaluation Factor Using Structural Equation

In the meantime, as one or more evaluation models generated in the step (a) S100, different evaluation models are generated depending on the technical field and the evaluation index of the patent. The evaluation index may be set to include an index indicating a degree for maintaining an exclusive status of the patent to be evaluated against a patent dispute with a third party (referred to as “rightness”), an index indicating a degree to which the patent to be evaluated accords with or leads the technology trend (referred to as technicality), and an index indicating a degree to which the patent to be evaluated is utilized in the business and an applicability (referred to as “usability). In this step, an evaluation factor which is finally used in an evaluation model for each index exemplified as rightness, technicality, and usability is determined to generate an evaluation model. However, the indexes of rightness, technicality, and usability are not limited to indexes referring to only the meaning of the corresponding word, and may be applied to an index used in the similar manner to the corresponding index.

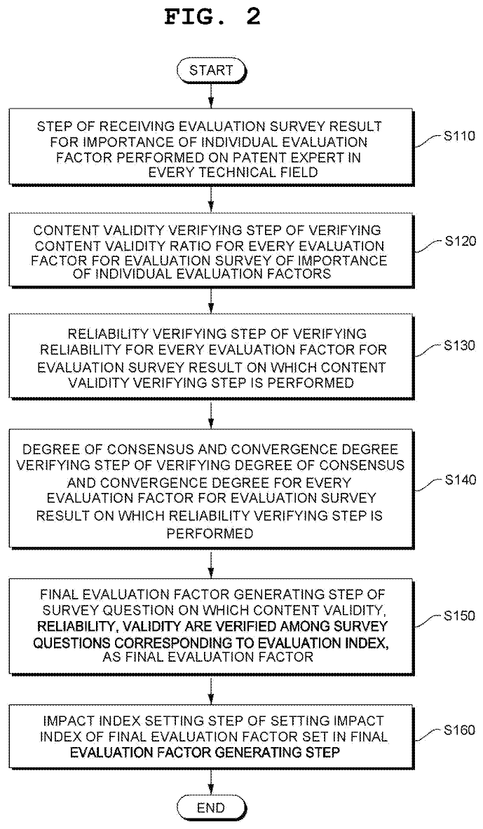

In the meantime, FIG. 2 is a specific flowchart of a step (a) of the present disclosure.

A key point of the step (a) S100 of the present disclosure is to generate a final evaluation factor used to evaluate the patent. Specifically, the final evaluation factor for patent evaluation is a step of selecting patent information finally used among various patent information which may be used to calculate evaluation indexes of rightness, technicality, and usability.

Referring to FIG. 2, the step (a) S100 includes (a) a step S110 of performing an evaluation survey for an importance of patent information on patent experts in every technical field, (2) a content validity verifying step S120 of verifying content validity ratio for every patent information with respect to an evaluation survey result for an importance of patent information, (3) a reliability verifying step S130 of verifying a reliability for the evaluation survey result on which the content validity verifying step S120 is performed, (4) a degree of consensus and convergence degree verifying step S140 of verifying a degree of consensus and a convergence degree for the evaluation survey result on which the reliability verifying step S130 is performed, (5) a final evaluation factor generating step S150 of setting patent information for which content validity, reliability, degree of consensus, and convergence degree for the evaluation survey result corresponding to the evaluation index are verified, as a final evaluation factor, and (6) an impact index setting step S160 of setting an impact index of each final evaluation factor set in the final evaluation factor setting step. In the meantime, the final evaluation factor and the impact index may vary depending on the technical field of the patent and the evaluation index of the patent.

2-(a)-(1) Surveying Step (Evaluation Factor Precede Evaluation Quantifying Step)

During the surveying step S110, an importance of individual evaluation factors (patent information) for patent evaluation is evaluated. In the present disclosure, survey evaluation results for individual evaluation factors of patent related experts are used. However, it should be noted that a major technical spirit of the present disclosure is to perform the pre-evaluating process on every evaluation factor to derive a final evaluation factor, rather than a survey process (human activity) performed by experts. In the following Table 1, some of survey questions for selecting the final evaluation factor corresponding to the evaluation index are represented.

TABLE 1

| | Strongly | | | | Strongly |
|---|---|---|---|---|---|
| | disagree | Disagree | Neutral | Agree | agree |
| Survey questions | (1) | (2) | (3) | (4) | (5) |

The more the independent
claims, the higher the
impact on rights
The shorter the length of
independent claim, the
higher the impact on
rights
The more dependent
claims, the higher the
impact on rights
The more claim series,
the higher the impact on
rights
The more drawings, the
higher the impact on
rights
The longer the length of
the description of the
patent, the higher the
impact on rights
The more the divisional
applications or claims of
priority, the higher the
impact on rights
The more overseas patent
families, the higher the
impact on rights
The more the IPC
assigned, the higher the
impact on rights.

In the meantime, the survey questions represented in Table 1 are quantified by pre-evaluating an importance of individual evaluation factors by performing the survey for evaluation indexes (rightness, technicality, and usability) on a patent expert group for every technical field. As exemplified, five-point scale may be quantified but the score scale is not limited to the five-point scale.

Content validity verification (CVR: content validity ratio), reliability verification, and degree of consensus and convergence degree verification may be performed on the survey results.

2-(a)-(2): Step of Verifying Content Validity of Evaluation Factor

More specifically, in the content validity verifying step S120, CVR is calculated for every survey result for every survey question and it is checked whether the calculated CVR value of the corresponding survey question satisfies a minimum CVR value in accordance with the number of survey respondents as presented in Lawshe (1975) of Table 2 and the patent information corresponding to unsatisfied survey question is removed from the evaluation factors.

TABLE 2

| | | | | | | | | | | | | | | | | |
|---|---|---|---|---|---|---|---|---|---|---|---|---|---|---|---|---|
| Number of | 5 | 6 | 7 | 8 | 9 | 10 | 11 | 12 | 13 | 14 | 15 | 20 | 25 | 30 | 35 | 40 |
| respondents | | | | | | | | | | | | | | | | |
| Min (CVR) | .99 | .99 | .99 | .75 | .78 | .62 | .59 | .56 | .54 | .51 | .49 | .42 | .37 | .33 | .31 | .29 |

$$CVR = \frac{( {n}_{g} - N / 2 )}{( N / 2 )}$$

nₑ: Number of answers that it is important, N: number of answers

(* C. H. Lawshe, “A quantitative approach to content validity”, Personnel psychology Vol. 28, 1975)

2-(a)-(3): Step of verifying Reliability of Evaluation Factor

During the reliability verifying step S130, the same concept is questioned with several questions and it is determined whether the items have similar values and the reliability may be verified by the following Cronbach alpha coefficient calculating equation. However, as for the reliability verifying method, the reliability verification is not limited to the following Cronbach alpha coefficient calculating equation.

$${Ep}^{2} = {σ}^{2} ( p ) / [ {σ}^{2} ( p ) + {σ}^{2} ( δ ) ]$$

Ep²: Reliability coefficient, σ²(p): variance, σ²(δ): relative error variance

In the meantime, the Cronbach alpha coefficient has a value between 0 and 1 and the higher the Cronbach alpha coefficient, the higher the reliability. For example, when the Cronbach alpha coefficient has a value of 0.8 to 0.9, it is determined that the reliability is very high and when the Cronbach alpha coefficient is 0.7 or higher, it is determined that the result is reliable.

In the present disclosure, when the Cronbach alpha coefficient for the survey result (5-point Likert scale) for specific patent information obtained as a result of an expert survey is 0.7 or smaller, the patent information is excluded from the evaluation factor.

2-(a)-(4): Degree of Consensus Regarding Evaluation Factor and Convergence Degree Verifying Step

During the degree of consensus and convergence degree verifying step S140, the degree of consensus (i.e. Agreement-degree) and the convergence degree are verified based on a median, a first quartile (25%), and a third quartile (75%) using the following equation.

Convergence⋅degree=(Q₃−Q₁)/2,⋅Agreement degree=(Q₃−Q₁/Mdn)

Mdn: Median, Q1 and Q3: First quartile (25%) and third quartile (75%), respectively

In the meantime, the closer the convergence degree is to 0, the smaller the deviation of the opinion and the closer the degree of consensus is to 1, the smaller the deviation of the opinion. In other words, the closer the convergence degree is to 0 and the closer the degree of consensus is to 1, the more proper the opinion.

As an application in the present disclosure, when the convergence degree calculated from the survey result for specific patent information is between 0 and 0.5 and the degree of consensus is between 0.75 and 1, it is determined that the opinion is proper.

2-(a)-(5): Final Evaluation Factor Setting Step

In the meantime, during the final evaluation factor setting step S150, among the survey items for every evaluation index, the survey questions (patent information) in which all the content validity, the reliability, the degree of consensus, and the convergence degree are verified are set as final evaluation factors and are applied to the structural equation to calculate an impact index for every final evaluation factor.

As described above, the final evaluation factor setting step is a step of setting evaluation factors remaining by excluding evaluation factors through the evaluation pre-evaluation result (expert survey), the content validity, the reliability, the degree of consensus, and the convergence degree verifying processes from evaluation factors (patent information) of each patent as final evaluation factors.
2-(a)-(6): Impact Index Calculating Step of Final Evaluation Factor

In the present disclosure, impact indexes for patent evaluation of the set final evaluation factors are set.

More specifically, the impact index is a value indicating whether the evaluation factors are independent from each other (impact index=0) or what kind of association is applied to the impact. As the impact index setting method, a Spearman sequence correlation analysis method, a Pearson correlation analysis method, a partial correlation analysis method, or a crossover analysis method may be used. The impact index is set such that anyone element of the final evaluation factors is set as a reference (1.00) and the remaining elements are represented as relative impact indexes for the one element set as the reference.
2-(b): Patent Information Obtaining Step

In the meantime, during (b) the step S200 of obtaining patent information from the patent to be evaluated, the patent information may be automatically obtained from a patent DB based on a unique identification number (Application number, Publication number, and Registered number) of the patent or the patent information of the patent to be evaluated may be input by a user. The obtained patent information refers to relevant information generated in association with the patent from the time of occurrence to the expiration of one patent, including an application form including a patent specification and drawings, an examination history, progress information (administrative information) after registration of rights. The patent information may include a technical field of the patent, application information, examination information, registration information, patent right information, patent trial information, and litigation information.

More specifically, the application information may include a number of independent claims, a length of an independent claim, a number of dependent claims, an average length of the dependent claim, a number of drawings, a length of a description of the invention, divisional application, a number of claims of priority, and a number of overseas patent families.

Further, the examination information may include a number of IPCs, early publication, accelerated examination, re-examination, a number of presented opinions, a number of provision of information, a total number of citation, a difference between a publication date of citation and a filing date of the patent to be evaluated, a number of papers/foreign patents among prior documents, a number of papers/foreign patents of cited documents. The registration information may include a number of annual registrations.

The patent right information may include a number of inventors, whether to determine registration for an extension of patent term, a number of licensees, a number of changed holders of right, a number of established pledge rights of a financial company.

In the meantime, the trial information may include a number of trials on invalidity, a number of appeals against decision of rejection, a number of quotation of trial to positive confirmation on the scope of rights, a number of rejection/withdraw/dismissal of trials to positive confirmation on the scope of rights, a number of rejection of trial to negative confirmation on the scope of rights, a number of quotation/withdraw/dismissal of trials to negative confirmation on the scope of rights, and a number of correction trials.

FIG. 3 is a view illustrating evaluation models according to various technical fields and evaluation indexes.

Referring to FIG. 3, it is confirmed that each evaluation model has one or more evaluation factors and each evaluation factor has an impact index corresponding to each elevation element.

More specifically, a rightness evaluation model in an electric/electronic/IT technical field has evaluation factors 1, 2, 3, and 5 and the impact indexes corresponding to evaluation factors are 0.69 for an evaluation factor 1, 0.86 for an evaluation factor 2, 1 for an evaluation factor 3, and 0.75 for an evaluation factor 5. Further, a technicality evaluation model in an electric/electronic/IT technical field has evaluation factors 4, 5, 6, and 8 and the impact index corresponding to each evaluation factor is as follows: 0.76 for an evaluation factor 4, 1 for an evaluation factor 5, 0.83 for an evaluation factor 6, and 0.87 for an evaluation factor 8. Therefore, it is confirmed that the evaluation factors and the impact indexes corresponding to the evaluation factors vary. In the meantime, in FIG. 3, the evaluation factors which are not connected to the rightness are not used as the evaluation elements for evaluating the rightness and in the same way, the evaluation factors which are not connected to the technicality are not used as the evaluation elements for evaluating the technicality.

In other words, even though the evaluation models are in the same technical field, if the evaluation index is different, the impact index corresponding to the evaluation factor of each evaluation model may be different.

In the meantime, even though the evaluation models are for the same evaluation index, if the technical field of the patent to be evaluated is different, the impact index corresponding to the evaluation factor of each evaluation model may be different.

For example, the rightness evaluation model in the electric/electronic/IT technical field has evaluation factors 1, 2, 3, and 5 and the impact indexes corresponding to the evaluation factors are 0.69 for an evaluation factor 1, 0.86 for an evaluation factor 2, 1 for an evaluation factor 3, and 0.75 for an evaluation factor 5 and the rightness evaluation model in the chemical/bio/material technical field has evaluation factors 1, 2, 3, 4, and 5 and the impact indexes corresponding to the evaluation factors are 0.65 for an evaluation factor 1, 0.52 for an evaluation factor 2, 1 for an evaluation factor 3, 0.82 for an evaluation factor 4, and 0.72 for an evaluation factor 5 so that it is confirmed that the impact indexes are different from each other.

2-(c): Application Evaluation Model Selecting Step

In the meantime, in the step (C) S300, for example, an evaluation model corresponding to the patent to be evaluated among one or more evaluation models, based on technical field information of the patent to be evaluated may be selected.

As described above, different evaluation factors and different impact indexes corresponding to the evaluation factor for every evaluation model are calculated depending on the technical field and the evaluation index so that only when the evaluation model corresponding to the patent to be evaluated is selected, an accurate evaluation result may be calculated.

In other words, when the technical field of the patent to be evaluated is electric/electronic/IT, if an evaluation model in the electric/electronic/IT technical field is selected, a reliable evaluation point may be calculated. In contrast, when the technical field of the patent to be evaluated is electric/electronic/IT but the evaluation model corresponding to the chemical/bio/material technical field is selected, since the evaluation index, the evaluation factor configuring the evaluation index, and the impact of the evaluation factor are different, an unreliable evaluation point may be calculated.

2-(d): Patent Evaluation Result Generating Step

In the meantime, during the evaluation result generating step S400 of a patent to be evaluated, the evaluation result may be generated by any one of a first method of generating the evaluation point as a comprehensive point by adding points corresponding to each evaluation index for the patent to be evaluated and a second method of generating the evaluation point for every evaluation index of the patent to be evaluated.

In the meantime, indexes of the rightness, technicality, and usability are assigned within a predetermined point. For example, the rightness point for the patent to be evaluated is assigned within 35 points, the technicality point is assigned within 35 points, and the usability point is assigned within 30 points. However, the points are not limited to the above-described points and it is sufficient if a sum of the points of indexes is equal to the maximum value of the evaluation points.

More specifically, as the evaluation result of specific individual patents calculated by the second method, points of the rightness, the technicality, and the usability index model are calculated as 33, 32, and 29, respectively and when the points are calculated by the first method, the points may be calculated as 94 obtained by adding 33, 32, and 29.

A specific calculating result equation for every evaluation index according to the second method may be set as follow.

y=a1*x1+a2*x2+ . . . +ai*xi

(x is each evaluation factor, a is a ratio of impact index of each evaluation factor to the total impact index, i is a natural number)

As described above, the impact index is set such that an impact index of a predetermined evaluation factor (reference evaluation factor) is set as 1 and then impact indexes of the remaining evaluation factors are set.

In the meantime, the patent evaluating method according to an illustrative embodiment of the present disclosure may further include an evaluation grade calculating step of calculating an evaluation grade of the patent to be evaluated based on the comprehensive point of the patent to be evaluated generated by the first method.

More specifically, during the evaluation grade calculating step, comprehensive points corresponding to all patents which are stored in the patent DB are calculated by the first method and then the comprehensive points corresponding to all the calculated patents are sorted in an ascending order and the grades may be divided according to a predetermined ratio.

Further, the evaluation grade of the patent to be evaluated may be calculated in accordance with a part of the grade divided by a predetermined ratio where the patent to be evaluated is located.

For example, the grade divided by a predetermined ratio is represented in the following Table 3.

TABLE 3

| | | | | | | | | | |
|---|---|---|---|---|---|---|---|---|---|
| Percentage | 4 | 7 | 12 | 17 | 20 | 17 | 12 | 7 | 4 |
| Cumulative | 4 | 11 | 23 | 40 | 60 | 77 | 89 | 96 | 100 |
| percentage (%) | | | | | | | | | |
| Grade | 1 | 2 | 3 | 4 | 5 | 6 | 7 | 8 | 9 |

A boundary value which divides the evaluation grade is exemplified as a percentage (%) and may also vary.

### 3. Patent Evaluating Process According to Illustrative Embodiment of the Present Disclosure

Hereinafter, a process of evaluating a patent in an electric/electronic/IT field using a patent evaluating method according to an illustrative embodiment of the present disclosure will be described.

A process of evaluating a patent “A” using a patent evaluating method according to an illustrative embodiment of the present disclosure includes (i) a step of obtaining patent information of a patent “A”, (ii) a step of selecting an evaluation model matching the patent information of the patent “A” of the step (i), and (iii) a step of generating a patent evaluation result for the patent “A” based on the patent information and the evaluation model of the patent “A” in the steps (i) and (ii).

More specifically, the patent information of the patent “A” obtained in the step (i) refers to relevant information generated in association with the patent from the time of occurrence to the expiration of one patent, including an application form including a patent specification and drawings, an examination history, progress information (administrative information) after registration of rights. The patent information may include a technical field of the patent, application information, examination information, registration information, patent right information, patent trial information, and litigation information.

More specifically, the application information may include a number of independent claims, a length of an independent claim, a number of dependent claims, an average length of the dependent claim, a number of claim series, a number of drawings, a length of a description of the invention, divisional application, a number of claims of priority, and a number of overseas patent families.

Further, the examination information may include a number of IPCs, early publication, accelerated examination, re-examination, a number of presented opinions, a number of provision of information, a total number of citation, a difference between citation and filing date, a number of papers/foreign patents among prior documents, a number of papers/foreign patents of cited documents. The registration information may include a number of annual registrations.

The patent right information may include a number of inventors, whether to determine registration for an extension of patent term, a number of licensees, a number of changed holders of right, a number of established pledge rights of a financial company.

In the meantime, the trial information may include a number of trials on invalidity, a number of appeals against decision of rejection, a number of quotation of trial to positive confirmation on the scope of rights, a number of rejection/withdraw/dismissal of trials to positive confirmation on the scope of rights, a number of rejection of trial to negative confirmation on the scope of rights, a number of quotation/withdraw/dismissal of trials to negative confirmation on the scope of rights, and a number of correction trials.

In the meantime, the method of selecting an evaluation model matching the patent information in the step (ii) may be a step of selecting an evaluation model corresponding to the technical field of the patent “A” and an index to be evaluated. For example, when the patent “A” is a patent in the electric/electronic/IT technical field and the rightness is evaluated, an evaluation model indicating a rightness index is selected from the evaluation model DB. When comprehensive evaluation for all evaluation indexes of the patent “A” is required, all evaluation models corresponding to the evaluation indexes may be selected.

In the meantime, after selecting the evaluation model through the above-described process, patent information of the patent “A” corresponding to the final evaluation factor of each evaluation model selected in the step (iii) may be input in the step (iii).

Table 4 represents evaluation factors of the evaluation model indicating the rightness index of the electric/electronic/IT technical field and impact indexes for each evaluation factor and Table 5 represents “A” patent information corresponding to the evaluation model.

TABLE 4

| | Electric•Electronic•IT rightness | |
|---|---|---|
| | evaluation model | |
| Patent information | | Impact |
| classification | Evaluation factor | index |
| Application | Number of independent claims | 1.00 |
| information | Length of independent claim | 0.71 |
| | Number of divisional applications | 0.68 |
| | and claims of priority | |
| | Number of overseas patent families | 0.50 |
| Examination | Number of provision information | 1.00 |
| information | Total number of citation | 0.20 |
| | Number of papers of cited | 0.61 |
| | documents/foreign patents | |
| Registration | Number of annual registrations | 1.00 |
| information | | |
| Patent right | Whether to determine registration | 1.00 |
| information | for an extension of patent term | |
| | Number of licensees | 0.52 |
| | Number of changed holders of right | 0.78 |
| Trial information | Number of trials on invalidity | 1.00 |
| | Number of quotation of trial to | 0.81 |
| | positive confirmation on the scope | |
| | of rights | |
| | Number of rejection of trial to | 0.96 |
| | negative confirmation on the scope | |
| | of rights | |
| | Number of correction trials | 0.15 |

TABLE 5

| Patent information | “A” patent information | |
|---|---|---|
| classification | Evaluation factor | Points |
| Application | Number of independent claims | 1 |
| information | Length of independent claim | 5 |
| | Number of divisional applications | 0 |
| | and claims of priority | |
| | Number of overseas patent | 3 |
| | families | |
| Examination | Number of provision information | 3 |
| information | Total number of citation | 6 |
| | Number of papers of cited | 2 |
| | documents/foreign patents | |
| Registration | Number of annual registrations | 5 |
| information | | |
| Patent right | Whether to determine registration | 5 |
| information | for an extension of patent term | |
| | Number of licensees | 1 |
| | Number of changed holders of right | 2 |
| Trial information | Number of trials on invalidity | 0 |
| | Number of quotation of trial to | 1 |
| | positive confirmation on the | |
| | scope of rights | |
| | Number of rejection of trial to | 1 |
| | negative confirmation on the | |
| | scope of rights | |
| | Number of correction trials | 0 |

Among the patent information for the patent “A” obtained in the step (i), the patent information of the patent “A” of Table 5 corresponding to the evaluation factors of Table 4 are input so that the points for the rightness evaluation result for the patent “A” may be obtained.

Although only the process of obtaining the rightness evaluation information for the patent “A” has been described above, evaluation results for the technicality and the usability of the patent “A” may also obtained using the above-described method.

In the meantime, the evaluation factor and the impact index of the model used to evaluate the technicality and the usability may be different from the evaluation factor and the impact index of the model used to obtain the rightness evaluation result. In the meantime, as the evaluation result points for the patent “A”, when the point for the rightness evaluation result is 32, the points of the technicality evaluation result and the usability evaluation result are 34 and 25, respectively, using the above-described method, the comprehensive point for the patent “A” may be 91 points obtained by adding the points for the rightness evaluation result, the points for the technicality evaluation result, and the points for the usability evaluation result.

In the meantime, relative evaluation for the patent “A” may also be performed by comparing the patent “A” with other patent stored in the patent DB.

For example, the relative evaluation of the patent “A” may be performed such that the comprehensive points for all patents stored in the patent DB are calculated by the above-described method and the calculated comprehensive points for all the patents are sorted in an ascending order, and the grades are divided in accordance with a predetermined ratio, and then the position of the patent “A” in the grades divided by a predetermined ratio is detected to assign a patent evaluation grade for the patent “A”.

More specifically, the grades divided in accordance with the predetermined ratio are represented in Table 6.

TABLE 6

| | | | | | | | | | |
|---|---|---|---|---|---|---|---|---|---|
| Percentage | 4 | 7 | 12 | 17 | 20 | 17 | 12 | 7 | 4 |
| Cumulative | 4 | 11 | 23 | 40 | 60 | 77 | 89 | 96 | 100 |
| percentage (%) | | | | | | | | | |
| Grade | 1 | 2 | 3 | 4 | 5 | 6 | 7 | 8 | 9 |

A boundary value of a patent grade assigning percentage (%) is exemplified as a percentage (%) and may also vary. When the patent grade for every technical field is generated based on the above-described contents, a status of the patent in the corresponding technical field may be checked. Further, a criterion for making a decision on maintenance and management of the patents may be suggested based thereon.

For example, an average grade of patents registered by an “A” electronics (a concerned company) is an AA level and an average grade of patents registered by a “B” electronics, it is evaluated that the status of the patents of the “A” electronics (the concerned company) is higher than that of the patents of the “B” electronics.

In the meantime, a boundary value of a percentage (%) for dividing the grades is exemplified as a percentage (%) and may also vary.

As another utilization plan, when patent evaluation results corresponding to a plurality of patents in a specific technical field of an arbitrary company are calculated and then the patent evaluation results are calculated on a year basis, it may be utilized as data for analyzing a fluctuation of patent evaluation of one company.

### 4. Patent Evaluating System According to Illustrative Embodiment of the Present Disclosure

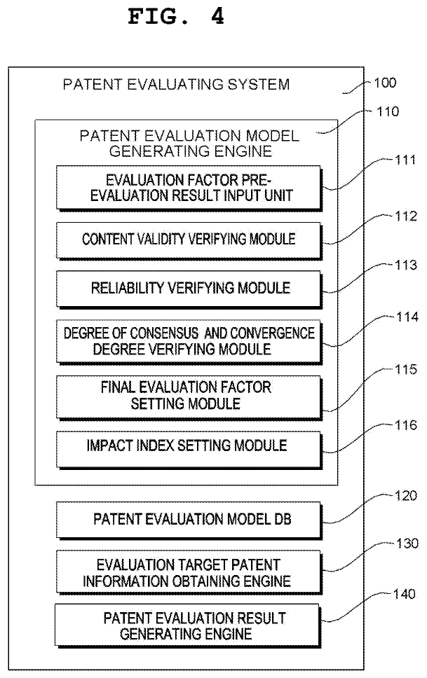

FIG. 4 is a diagram of a patent evaluating system using a structural equation model according to an illustrative embodiment of the present disclosure.

The patent evaluating system 100 according to an illustrative embodiment of the present disclosure includes a patent evaluation model generating engine 110 which generates a patent evaluation model, a patent evaluation model DB 120 in which a patent evaluation model generated in the patent evaluation model generating engine 110 is stored, an evaluation target patent information obtaining engine 130 which obtains information of a patent to be evaluated, and a patent evaluation result generating engine 140 which generates a patent evaluation result based on the information of the patent to be evaluated obtained from the patent information obtaining engine 130 and the patent evaluation model stored in the patent evaluation model DB 120. According to an illustrative embodiment of the present disclosure, the components may be distributed in one or more servers connected through a wired/wireless network.

More specifically, the patent evaluation model generating engine may perform the step (a) S100 of the patent evaluating method using a structural equation according to an illustrative embodiment of the present disclosure.

In other words, the patent evaluation model generating engine 110 may generate one or more different patent evaluation models in accordance with the technical field of the patent and the evaluation index using a structural equation. The evaluation indexes may include an index indicating a degree for maintaining an exclusive status of the patent to be evaluated against a patent dispute with a third party (referred to as “rightness”), an index indicating a degree to which the patent to be evaluated accords with or leads the technology trend (referred to as technicality), and an index indicating a degree to which the patent to be evaluated is utilized in the business and an applicability (referred to as “usability).

In the meantime, the patent evaluation model generating engine 110 may include an evaluation factor pre-evaluation result input unit 111 which receives pre-evaluation result of importance for every patent evaluation factor, a content validity verifying module 112 which verifies the content validity of the received importance pre-evaluation result for every patent evaluation factor, a reliability verifying module 113 which verifies a reliability for the importance pre-evaluation result for the patent evaluation factor on which the content validity is performed, a degree of consensus and convergence degree verifying module 114 which verifies the degree of consensus and the convergence degree for the importance pre-evaluation result for the patent evaluation factor on which the reliability validation is performed, a final evaluation factor setting module 115 which sets a final evaluation factor based on the verification results of the content validity verifying module 112, the reliability verifying module 113, and the final evaluation factor setting module 115, and an impact index setting module 116 which sets an impact index for every final evaluation factor.

The content validity verifying module 112 performs the content validity verifying step S120 of the present disclosure, the reliability verifying module 113 performs the reliability verifying step S130, and the degree of consensus and convergence degree verifying module 114 performs the degree of consensus and convergence degree verifying step S140.

Further, the final evaluation factor setting module 115 and the impact index setting module 116 may performs the final evaluation factor generating step S150 and the impact index setting step S160 of the above-described patent evaluating method using a structural equation according to the illustrative embodiment of the present disclosure.

The final evaluation factors and the impact indexes may vary depending on the technical field of the patent and the evaluation indexes of the patent. The impact index may be set such that an impact index of any one evaluation factor among the final evaluation factors is set as 1 and the impact indexes of the remaining final evaluation factors may be relatively set based on the impact index of any one evaluation factor which is set to be 1.

In the meantime, the evaluation target patent information obtaining engine 130 may obtain patent information of the patent to be evaluated by searching a patent DB in which a patent specification, drawings, and relevant patent information are loaded, with respect to an application number, a publication number, a registration number of the patent to be evaluated, or receive the patent information of the patent to be evaluated from a user. The patent information of the patent to be evaluated refers to relevant information generated in association with the patent from the time of occurrence to the expiration of one patent, including an application form including a patent specification and drawings, an examination history, progress information (administrative information) after registration of rights. The patent information may include a technical field of the patent, application information, examination information, registration information, patent right information, patent trial information, and litigation information.

Further, the evaluation target patent information obtaining engine 130 may evaluate the patent in accordance with the procedure described in the present disclosure by obtaining the patent information for entire patents of a predetermined DB, instead of obtaining the patent information by searching individual patents from the patent DB. Further, the patent DB may be grouped for a predetermined technical field and for a right holder and during the process of obtaining the patent information, the system may evaluate the patents by extracting patents from the patent DB for a predetermined technical field and a right holder, in accordance with requirements.

For example, in the patent DB of the present disclosure, patent specifications and drawings of entire patents of Korea and available foreign countries for a predetermined period or a present time and relevant patent information may be loaded. (1) When the patent evaluation is performed for a predetermined individual patent, the patent information of the corresponding patent is obtained to be input to the evaluation model of the present disclosure to perform the evaluation and (2) patent information for a patent group for every country or every company (every applicant) for patents during a predetermined period is extracted from the patent DB to perform the patent evaluation for the corresponding patent group. In this case, as it will be described below, the evaluation grade for a predetermined patent group may be calculated and the patent groups may also be compared.

In the meantime, the application information may include a number of independent claims, a length of an independent claim, a number of dependent claims, an average length of the dependent claim, a number of claim series, a number of drawings, a length of a description of the invention, divisional application, a number of claims of priority, and a number of overseas patent families.

Further, the examination information may include a number of IPCs, early publication, accelerated examination, re-examination, a number of presented opinions, a number of provision of information, a total number of citation, a difference between citation and filing date, a number of papers/foreign patents among prior documents, a number of papers/foreign patents of cited documents. The registration information may include a number of annual registrations.

The patent right information may include a number of inventors, whether to determine registration for an extension of patent term, a number of licensees, a number of changed holders of right, a number of established pledge rights of a financial company.

In the meantime, the trial information may include a number of trials on invalidity, a number of appeals against decision of rejection, a number of quotation of trial to positive confirmation on the scope of rights, a number of rejection/withdraw/dismissal of trials to positive confirmation on the scope of rights, a number of rejection of trial to negative confirmation on the scope of rights, a number of quotation/withdraw/dismissal of trials to negative confirmation on the scope of rights, and a number of correction trials.

In the meantime, the patent evaluation result generating engine 140 may generate the evaluation result by any one of a first method of generating the evaluation point as a comprehensive point by adding point corresponding to each evaluation index for the patent to be evaluated and a second method of generating the evaluation point corresponding to every evaluation index (rightness, technicality, and usability).

In the meantime, the patent evaluating system 100 according to an illustrative embodiment of the present disclosure may further include an evaluation grade calculating unit which calculates an evaluation grade of the patent to be evaluated based on the comprehensive point of the patent to be evaluated generated by the first method.

More specifically, the patent evaluation grade calculating unit may include a normal distribution function generating module which generates a normal distribution function based on the comprehensive point corresponding to each of the plurality of patents in the technical field same as the patent to be evaluated by the first method in the patent evaluation result generating engine.

As described above, the grade of the patent to be evaluated may be calculated depending on a position of the comprehensive point of the patent to be evaluated in the normal distribution function.

When the patent grade for every technical field is generated based on the above-described contents, a status of the patent in the corresponding technical field may be checked. Further, a criterion for making a decision on maintenance and management of the patents may be suggested based thereon.

For example, an average grade of patents registered by an “A” electronics (a concerned company) is an AA level and an average grade of patents registered by a “B” electronics, it is evaluated that the status of the patents of the “A” electronics (the concerned company) is higher than that of the patents of the “B” electronics.

In the meantime, a boundary value of a percentage (%) for dividing the grades is exemplified as a percentage (%) and may also vary.

As another utilization plan, when patent evaluation results corresponding to a plurality of patents in a specific technical field of an arbitrary company are calculated and then the patent evaluation results are calculated on a year basis, it may be utilized as data for analyzing a fluctuation of patent evaluation of one company.

In the meantime, the present disclosure may also be configured to include a computer program executing the above-described patent evaluating method using a structural equation according to an illustrative embodiment of the present disclosure and a computer readable storage medium in which the computer program is stored.

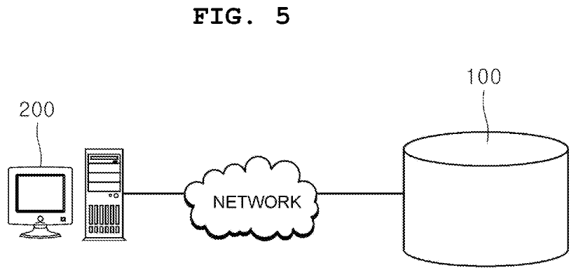

As illustrated in FIG. 5, the patent evaluating system using a structural equation according to an illustrative embodiment of the present disclosure may be configured by at least one patent evaluating systems or servers 100 and the server 100 is connected to a wired/wireless network to provide the patent evaluation result to a user device 200. When the server 100 receives a request for an evaluation service for a specific patent from the user device 200, the server 100 may provide an evaluation result for the patent and a detailed operating method has been described above.

The server 100 according to an illustrative embodiment of the present disclosure may include a processor, a memory which stores and executes program data, a permanent storage unit, a communication port communicating with an external device, and a user interface device. Methods implemented by a software program module or algorithm may be stored on a computer readable storage medium as computer readable codes or program commands which can be executed on the processor. The computer readable recording medium is distributed in computer systems connected through a network and computer readable code is stored therein and executed in a distributed manner.

In the meantime, the technical spirit of the present disclosure has been specifically described according to the illustrative embodiment, but it should be noted that the illustrative embodiments are for explanation purposes only and not for the purpose of limitation. Further, it will be understood by those skilled in the art that various embodiments are allowed within the technical spirit of the present disclosure.

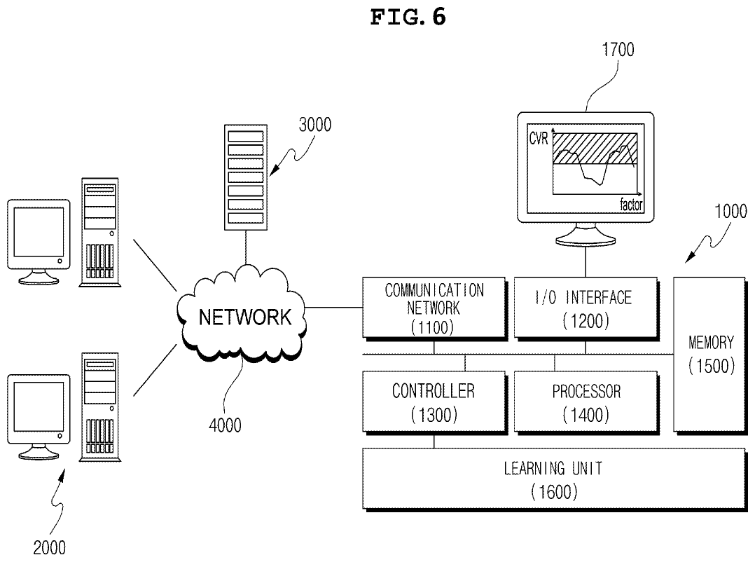

FIG. 6 illustrates a second example of a system including a computing apparatus which evaluates an attribute of a patent content according to another illustrative embodiment of the present disclosure. However, the following illustrative embodiment is described in terms of practical application in which the invention described in the prior application is carried out by a physical device such as a computing apparatus so that the technical spirit included in the following second example and the technical spirit included in the first example which has been described above are substantially identical. Hereinafter, even though the description overlaps the description of the prior application, the description will be repeated in terms of practical application of the components of the present illustrative embodiment.

A system of FIG. 6 includes a computing apparatus 1000, an external computing apparatus 2000, a patent content management server 3000, and a network 4000. The computing apparatus 1000 evaluates an attribute of patent content using class information to provide a result according to the attribute of the patent content. The computing apparatus 1000 is a device in the practical aspect for engines represented as a patent evaluation model generating engine 110, an evaluation target patent information obtaining engine 130, and a patent evaluation result generating engine 140 in the above-described example.

Here, the class information may be a classification code for specifying a technical field or a set to which the patent content pertains. The class information may be information for classifying (for example, electric and electronic/mechanics/chemical/bio fields) according to industrial fields or classification code information according to IPC or CPC classification. The class information for each class may be separately assigned after filing an application of the patent document or specified according to an automated technology.

Here, the patent content may be document type contents which are filed to Patent Office in each country, published/registered document type contents, or contents obtained by processing the documents. The attribute refers to the rightness, technicality, and usability for the patent contents as described above. The result according to the attribute may be a comprehensive score obtained by collecting scores (attribute evaluation feature values) for the attribute. Further, the comprehensive score may be provided in the form of a distribution curve represented by a text image, an evaluation score, a text message, an image, or a video. Further, the result may be externally expressed visually or audibly through the display unit 1700 such as a monitor.

The computing apparatus 1000 of the present embodiment includes a communication interface 1100, an I/O interface 1200, a controller 1300, a processor 1400, a memory 1500, and an artificial neural network 1600.

The communication interface 1100 may be connected to a plurality of computing apparatuses 2000 and a patent content management server 3000 at the outside via a network 4000. Here, the external computing apparatus may be an apparatus which inputs a reference score related to the evaluation factor which configures an evaluation factor set as represented in Table 1. The content management server 3000 may further include a training data storage (not illustrated) which stores training patent content information used for the training. The training data storage may further store information such as attribute evaluation feature values which have been performed on the corresponding patent contents, together with the patent content information as training data.

The patent content information included as training data may be patent content information from a very large number of patents and patent applications (thousands, tens of thousands, hundreds of thousands, or more, depending on the technical field), and may be periodically updated as more patent content information becomes available. As a result, the patent content information included as training data may be too large for a human being to comprehend, especially in a practical period of time.

The I/O interface 1200 is an interface which connects the processor 1400 and a peripheral device such as the display unit 1700.

The controller 1300 controls a connection weight of the artificial neural network 1600 based on the reference score for each of evaluation factors calculated in the processor. To be more specific, the connection weight may be controlled based on the class information and first to third reference scores.

Here, the evaluation factor is one factor included in a previously set evaluation factor set. As illustrated in Table 4, the evaluation factor set is a set of evaluation factors. The evaluation factor is an individual item required to evaluate the patent contents. The reference score is a score indicating whether each evaluation factor is suitable to evaluate an attribute of the patent contents. The reference score may be a score received from an expert for each technical field as described above or a score which is calculated or predicted based on the existing patent content evaluation result.

Here, the first reference score is information regarding the content validity of each evaluation factor to evaluate the attribute of the patent content from the plurality of external computing apparatus. The first reference score is a CVR value as described above, for example. Next, the second reference score represents a similarity between reference scores acquired for each evaluation factor, from the same computing apparatus at different timings. As described above, the second reference score may be a relative error variance, specifically, a Cronbach alpha coefficient. The third reference score is a score representing a convergence attribute of the first reference scores (or selected first reference scores) acquired for each evaluation factor from the plurality of computing apparatus. For example, the third reference score may be the above-described convergence degree or agreement degree, for example.

The processor 1400 receives an input score according to the technology class information for the class to which the target patent contents whose attribute is to be evaluated pertains and the evaluation factors included in the predetermined evaluation factor set to evaluate the attribute of the patent contents. Further, the processor selects at least some evaluation factors selected according to the class information, among the evaluation factors included in the evaluation factor set. The processor calculates the attribute evaluation feature value of the target patent content using input scores for each of the evaluation factors, and weights which are determined in advance to be different depending on the class information and the evaluation factor. Next, the attribute for the target patent content is represented as a text or an image using the attribute evaluation facture value. The detailed configuration and the operation of the processor will be described below.

In the present embodiment, the attribute of the patent content refers to a feature estimated from the input score according to the evaluation factor. The attribute includes an attribute with good technicality of the patent content, an attribute which is frequently cited through a plurality of follow-up documents, a pattern of increasing demand in the market. Such an attribute may be quantitatively calculated from the input score.

The attribute evaluation feature value indicates a conformity of the patent content with regard to an arbitrary attribute. Alternatively, the attribute evaluation feature value refers to a prediction value for an arbitrary attribute of the patent content. Here, the attribute evaluation feature may conceptually correspond to the calculation of a feature value from an arbitrary video or voice. However, in the present disclosure, the processor calculates the feature value by an operation (for example, an addition according to the weight) using input scores for selected evaluation factors and the predetermined weights, based on the evaluation factors which are selected according to the technology classification. This is different from the related art.

The memory 1500 stores the program to be executed in the processor and the above-described reference score. Specifically, the memory may store a history of the past reference score information so as to know time-series change in the reference score.

The artificial neural network 1600 receives the input score from the processor and calculates the attribute evaluation feature value representing an attribute of the target patent content. The artificial neural network 1600 includes a plurality of nodes and connection weights which connect the nodes. The controller 1300 controls to set different connection weights of the artificial neural network in consideration of the class information of the target paten contents.

The display unit 1700 is a device which provides visual or audible results according to the attribute evaluation feature value. For example, the display unit 1700 may be a monitor or a speaker. The attribute evaluation feature value may be displayed on the monitor in the form of a text, a score, an image, or a statistical analysis graph.

The computing apparatus 1000 in the system of FIG. 6 is an apparatus which configures a server which evaluates the attribute for the patent contents or configures a part of the server. The external client terminal may request the computing apparatus 1000 of the present disclosure to evaluate the patent content via the network 4000 and the computing apparatus 1000 provides a visualized distribution curve image through the user interface device, such as a monitor, as the patent content evaluation result according to the request. Further, the computing apparatus 1000 may visually provide a time-series change of the attribute evaluation feature value or the CVR value through a directly connected monitor. The memory 1500 stores the history information for the attribute evaluation feature value or the CVR value. The computing apparatus 1000 monitors the change of the attribute evaluation feature value for an arbitrary patent content over the time through the learning unit and senses a patent content which shows a specific change. The patent contents sensed as described above may be patent contents having a changed technology classification, to be assigned with a new technology classification, or having a feature value which is significantly changed recently. Here, in order to sense the patent content which shows a specific change, for example, the learning unit may easily sense the characteristic change between the previously stored distribution curve image and the current distribution curve image, through an artificial neural network, such as CNN. Detailed matters thereof will be described below.

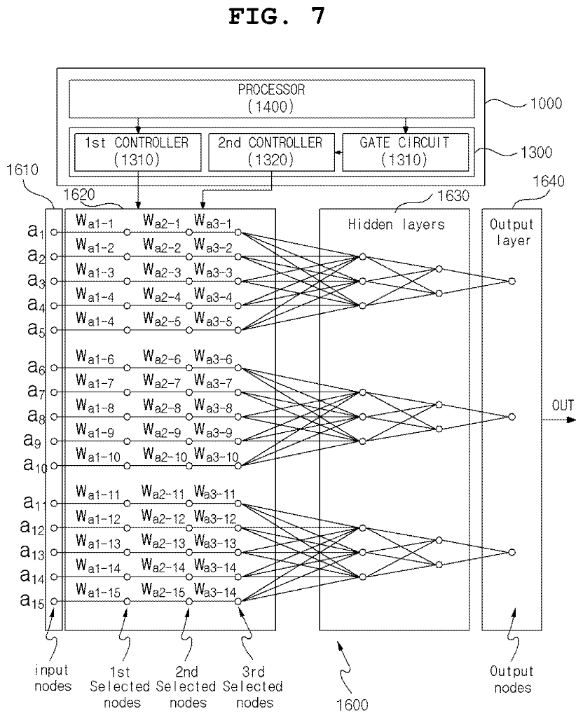

FIG. 7 is a detailed block diagram of a processor 1400, a controller 1300, and an artificial neural network 1600 illustrated in FIG. 6.

As illustrated in FIG. 7, the controller 1300 includes a first controller 1310, a second controller 1320, and a gate circuit 1330. The controller 1300 controls an operation of the artificial neural network 1600 and may be implemented as software which is executed in the processor or a micro controller which is separately provided to control the operation of the artificial neural network.

The first controller 1310 selects first selected nodes of a selection layer 1620 according to the first reference score or transmits a control value for limiting the connection weight to the artificial neural network. Here, the first reference score may be a CVR value mentioned in the first example. The first controller generates a first control value depending on whether the first reference score calculated for each evaluation factor satisfies a predetermined criterion (a reference value for verifying the CVR) and transmits the first control value to the artificial neural network.

The selection layer 1620 includes first selected nodes, second selected nodes, and third selected nodes. 1-1-th connection weights which connect the first selected nodes and the second selected nodes may be connected in one to one relationship as illustrated in FIG. 7 or a many to many relationship.

To be more specific, when a first reference score of an arbitrary evaluation factor a3 is smaller than a predetermined reference value (that is, it means that the evaluation factor is a minor sub evaluation factor which is not important), the first controller 1310 transmits a control value which sets a connection weight w₁₋₃ of the evaluation factor a₃ 0 to the artificial neural network 1600. This is the same manner as the above-described embodiment. Further, for minimum restrictions on the operation of the artificial neural network 1500 regarding the connection weight update through the training data, it may be implemented to transmit a control value which updates a values of the 1-1-th connection weights of the minor evaluation factor within a limited range through the learning process to the artificial neural network. For example, when the evaluation factor a₃ is a minor evaluation factor, the control value may be a control value which does not strongly restrict the connection weight w₁₋₃ to 0, but limits the connection weights to the range of 0 to 0.3. Of course, various ranges may be set according to the requirement of the system.

The second controller 1320 generates a second control value according to a logical operation result of the gate circuit to transmit the second control value to the artificial neural network. The second controller selects the second selected nodes or the third selected nodes of the selection layer 1620 according to the second reference score or the third reference score or transmits the second control value which restricts the connection weights to the artificial neural network. The gate circuit 1330 transmits a selection result which selectively or collectively reflects the results according to the second reference score and the third reference score to the second controller 1320, through an AND gate or an OR gate for the second reference score or the third reference score calculated for each evaluation factor by the processor.

As described in the above-described illustrative embodiment, the processor calculates the second reference score for every evaluation factor in the same manner as the reliability verifying step of 2-(a)-(3) and when the second reference score is lower than a predetermined criterion, makes a decision to exclude the corresponding evaluation factor or set a determination weight of the evaluation factor to be low. Further, the processor calculates the third reference score for every evaluation factor and makes the decision for the third reference score in the same manner as the second reference score, in the same manner as the method of verifying an agreement degree and a convergence degree of 2-(a)-(4).

The gate circuit 1330 performs a logical operation on whether the second reference score calculated for each evaluation factor satisfies another predetermined criterion (a reliability verification criterion described in the first example) or whether the third reference score satisfies another predetermined criterion (agreement degree and convergence degree verification criterion described in the first example).

To be more specific, the gate circuit 1330 may perform an “AND” operation for selecting only an evaluation factor for which both the second reference score and the third reference score satisfy the determined criterion or an “OR” operation for selecting an evaluation factor when only one of them satisfies the criterion. The second controller generates a control value according to the evaluation factor selection result determined by the gate circuit to transmit the control value to the artificial neural network.

The artificial neural network may determine a connection weight of second and third selected nodes to be 1 according to the selection result according to the second and third reference scores. Alternatively, the artificial neural network performs the learning in a limited range of the connection weight such that the connection weight for the nodes selected according to the second and third reference scores is not 1, but is within the range of 0.7 to 1 and determines the connection weight according to the result of the learning as a final value.

The learning of the artificial neural network 1600 may include supervised learning, non-supervised learning, and reinforcement learning. According to the supervised learning, for example, patent contents having attribute evaluation information on which the evaluation is already completed are used as training data to determine a connection weight. Even though in a normal artificial neural network, the connection weight is not specifically limited, according to the present embodiment, a predetermined limit is applied to the connection weight based on the reference score.

The artificial neural network 1600 includes an input layer 1610, a selection layer 1620, a hidden layer 1630, and an output layer 1640. The artificial neural network 1600 may be implemented as software which is implemented in the processor or may be implemented as hardware such as a separate artificial neural network circuitry having a separate processor and a separate memory therein or a graphic processing unit (GPU). The artificial neural network of the present embodiment may be implemented by various modified forms of the artificial neural network, as well as a convolutional neural network (CNN), a recurrent neural network (RNN), a long short-term memory (LSTM), autoencoder, deep feedforward network (DFN), and generative adversarial network (GAN).

The attribute of the patent contents relies on a technical field to which the technology included in the patent contents pertains. As described in the above-described embodiment, the values of the evaluation items vary depending on the electric/electronic fields and chemical/bio fields. The artificial neural network of the present disclosure is different from the learning method of the related art in that the learning of excluding some of the evaluation items or adjusting the weight to a low range is performed in consideration of the already acquired class information.

Apart from the fact that values which are input to the input nodes a₁ to a₁₅ are input scores, the connection weight which is connected to the input node is limited in a predetermined range by a control value which reflects the importance of each input node, which is one of important technical features of this disclosure. By doing this, the attribute of the patent content may be evaluated by reflecting the correlation between the input score and the importance for every evaluation factor (which is different according to the technology class information). Further, sub classification on the technology class information (technology classification code) is easy and an artificial neural network having a separate learning for every sub classification may be easily constructed.

The artificial neural network of the present disclosure may update the connection weight by regular or non-regular learning. The technical field may be changed according to the elapse of time and a new technical field may be generated and the patent contents are deeply related to the time-series changes of the technologies. An error calculating unit (not illustrated) compares an attribute evaluation result according to the training data and an attribute evaluation result according to the current artificial neural network and detects a technology group (various technology classification codes such as IPC or CPC or a group which includes a specific keyword or is classified as similar technologies as a result of determining a similarity) from which significant change is sensed as the comparison result. That is, when a new group related to the new technology is sensed, the artificial neural network is updated by immediate learning and if it is significant to add a new technology classification as the update result, the technology classification may be added.

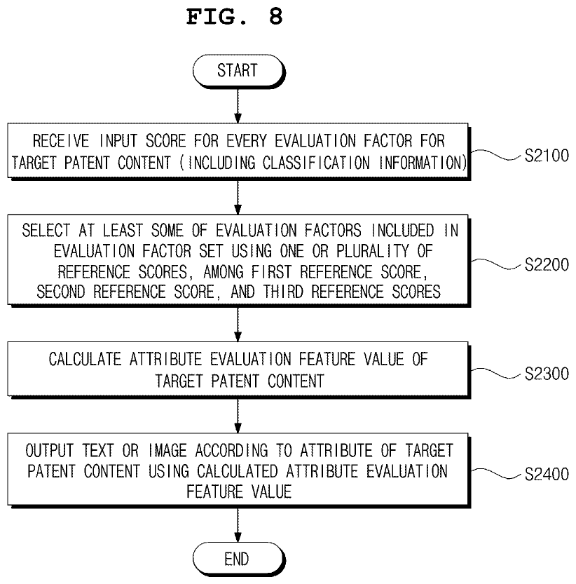

The artificial neural network 1600 further includes a hidden layer 1630 and an output layer 1640. The output layer 1640 includes one or more output nodes and an output of the output layer is an attribute evaluation feature value for the target patent or a value obtained by processing the attribute evaluation feature value. In the hidden layer 1630, nodes which are selected by the selection layer 1620 or have a connection weight in a limited range and output nodes are connected through the connection weight. As illustrated in FIG. 8, the hidden layer is configured by a plurality of layers.

According to still another embodiment of the present disclosure, the feature value may also be extracted through the artificial neural network trained by LGBM. The light GBM (LGBM) is appropriate to build a classification tree for a large amount of materials which are cumulatively increased, such as patent contents. Of course, in order to supplement the problem of the gradient boosting machine (GBM) of the related art that calculates a weight by a gradient boosting, there is a method such as xgboost. However, while the boosting algorithm such as xgboost has a high accuracy, it has a problem in that a large amount of computation for learning is necessary. Further, it is necessary to perform tuning with many hyper parameters so that there is a processing burden therefor. According to the tree structure of the related art, the tree is built with a concept of horizontally expanding while maintaining a balance of the tree through horizontal expansion. However, according to the LGBM, the tree may be built with a concept of vertically expanding while consistently dividing a leaf node without considering a computation for the balance of the tree. Therefore, the tree structure obtained by the vertical expansion is asymmetrical and has a deep level depth. Further, when such a leaf-wise method is used, a burden of computation when the leaf is generated may be further reduced as compared with the level-wise method.

FIG. 8 is a flowchart illustrating a patent content attribute evaluating method according to still another illustrative embodiment of the present disclosure, performed in the computing apparatus of FIG. 7. FIG. 8 includes the following steps which are time-sequentially performed in the computing apparatus of FIG. 7. The example illustrated in FIG. 8 substantially overlaps the second example and the first example so that the common description will be omitted.

In step S2100, the processor 1400 receives the technology class information for the class to which the target patent contents with an attribute to be evaluated pertains and an input score according to the evaluation factors included in the evaluation factor set predetermined to evaluate the attribute of the patent contents. Here, the target patent content is a patent to be evaluated. The input score is a score of the target patent content for each evaluation factor, and for example, is a score for every evaluation factor, as represented in Table 5 above.

In step S2200, the processor 1400 selects at least some evaluation factors according to the class information, among the evaluation factors included in the evaluation factor set. Specifically, the processor selects at least some of the evaluation factors included in the predetermined evaluation factor set in consideration of one or a plurality of the first reference score, the second reference score, and the third reference score. A detailed configuration therefor has been illustrated in FIG. 7.

In this step, the processor may exclude some evaluation factors and select some evaluation factors as effective evaluation factors. At this time, the connection weight of the effective evaluation factors is 1 and the connection weight of the excluded evaluation factors is 0. The processor may determine to allow the connection weight to have a limited range with an upper limit and a lower limit. The artificial neural network performs the learning for updating a connection weight within a limited range according to a control value which is calculated by the processor and is provided from the controller. The connection weight acquired therefrom may be 0 or 1, but the connection weight may be adaptively adjusted to have a value of 0.15 instead of 0 and a value of 0.92 instead of 1.

In step S2300, the artificial neural network 1600 calculates an attribute evaluation feature value for the target patent content. The artificial neural network calculates the attribute evaluation feature value of the target patent content using input scores for the selected evaluation factors and weights which are determined in advance to be different depending on the class information and the evaluation factor. A specific configuration for calculating the attribute evaluation feature value using the class information and the weights has been illustrated in FIG. 7.

In step S2400, the processor 1400 generates an output signal to display the attribute of the target patent content to the outside using the calculated attribute evaluation feature value. For example, the processor may display the attribute in the form of text such as the final evaluation score. Further, the processor may display the attribute of the patent contents in the form of an image or a statistical analysis graph, through the user interface. When it is possible to visually express the attribute of the patent contents which time-sequentially changes, the processor may easily detect the change of the pattern between compared images by comparing the image which is currently visualized and images which were visualized in the past. When the change of the pattern is deviated from a predetermined criterion, the processor may newly create a technology classification, change the technology classification code, or provide a message that the weight needs to be readjusted (retrained) to the user. When the pattern is not similar not only to the pattern of the current group, but also to the pattern of the other group, it is necessary to newly create the technology classification for the current patent contents from which the change of the pattern is detected. When the change of the pattern is generated not only from some of the patent contents, but also from a large number of patent contents, it is necessary to readjust the weight. In this case, the processor determines whether the time-series deviation between the attribute evaluation feature values of the patent contents belonging to the same class information satisfies a predetermined criterion. When it has the directivity that the time series deviation is increased from the viewpoint of the time domain, the processor transmits an instruction to perform the learning for updating the connection weight to the artificial neural network and the artificial neural network performs the learning with training data and data acquired from the currently acquired new patent content as an input.

The output of step S2400 may be used in the practical application of intellectual property portfolio management, including in decisions related to pursuing, maintaining, challenging, licensing, or acquiring a patent or patent application. Such decisions often have large financial import, and can determine the survival of a product line or company

According to still another illustrative embodiment of the present disclosure, the present disclosure may be implemented by a computer program which is stored in a computer readable recording medium to evaluate the attribute of the patent content as described above.

According to the illustrative embodiment of the present disclosure, the burden on the processing consumed to evaluate the attributes (rightness, technicality, and usability) of the patent content, specifically, the patent content having technology class information may be reduced. For example, the burden of the processing consumed to calculate a momentum to escape from the error of the local minimum value caused by the random initialization may be reduced. By doing this, the learning amount required to update the attribute evaluation of the patent content is reduced, and consequently, a computational amount and a time consumed to update the attribute evaluation may be reduced. Further, the range of the value of the determination weight which connects some nodes (nodes on the selection layer) of the artificial neural network is limited using the class information to which the attribute for every technical field so that the time consumed for the learning may be reduced and the adequacy of the evaluation result may be improved.

In the present disclosure, a substantial application of the present disclosure has been described through a separate second illustrative embodiment. However, the second illustrative embodiment has the same essential technical matters as the first illustrative embodiment included in the prior application to which this application claims priority.

What is claimed is:

1. A computing apparatus comprising:
at least one processor; and a non-transitory computer-readable memory storing executable instructions thereon, wherein the at least one processor programmed by the executable instructions performs operations comprising:
receiving a class information and an input score for a target patent content to be evaluated, wherein the class information comprises a classification code for specifying a technical field of the target patent content, and wherein the input score corresponds to each of evaluation factors included in a predetermined evaluation factor set;
selecting at least some evaluation factors among the evaluation factors included in the predetermined evaluation factor set, based on the class information;
calculating an attribute evaluation feature value of the target patent content using the input score for each of the evaluation factors and weights which are determined in advance to be different depending on the class information; and
providing a text or an image according to the attribute evaluation feature value of the target patent content to a user interface of the computing apparatus.

2. The computing apparatus according to claim 1, wherein the calculating of the attribute evaluation feature value includes:
inputting the input score to an artificial neural network which is trained in advance to be differently determined according to the class information and the evaluation factor, and
calculating an attribute evaluation feature value representing the attribute of the target patent content by the artificial neural network.

3. The computing apparatus according to claim 1, wherein the selecting of at least some of evaluation factors includes:
selecting at least some evaluation factors among the plurality of evaluation factors included in the evaluation factor set, based on a first reference score stored in a training data storage, wherein the first reference score is information related to content validity of each evaluation factor for evaluating the attribute of the patent content and is received from a plurality of external computing apparatuses which is connected via a network.

4. The computing apparatus according to claim 2, wherein the artificial neural network includes a plurality of nodes and connection weights which connect the nodes and some connection weights among the connection weights are determined according to the first reference score.

5. The computing apparatus according to claim 4, further comprising:
a communication interface for communication with the plurality of external computing apparatuses; and
a controller which controls values for some connection weights among the connection weights, in consideration of the first reference score.

6. The computing apparatus according to claim 1, wherein the selecting of at least some evaluation factors among the evaluation factors included in the predetermined evaluation factor set including:
comparing one or more reference scores selected from a group consisting of the first reference score, a second reference score which represents a similarity between reference scores acquired for each evaluation factor at different timings from the same computing apparatus and is calculated by the processor, and third reference scores which represent a convergence attribute of the first reference scores acquired for each evaluation factor from the plurality of computing apparatus and are calculated by the processor with a predetermined reference value; and
selecting at least some evaluation factors among the plurality of evaluation factors included in the predetermined evaluation factor set according to a comparison result.

7. The computing apparatus according to claim 6, wherein the first reference score is related to the content validity of each evaluation factor and includes already acquired content validity ratio (CVR) information and the third reference score includes an agreement degree or a convergence degree related to the convergence attribute for each evaluation factor.

8. The computing apparatus according to claim 1, wherein the weight is an impact index representing an impact for each evaluation factor to calculate the attribute evaluation feature value, and the impact index is a relative impact index representing a relative impact as compared with an impact of one reference evaluation factor among the selected evaluation factors.

9. The computing apparatus according to claim 1, wherein the computing apparatus further includes a first controller, a second controller, and a gate circuit,
the first controller generates a first control value depending on whether the first reference score calculated for each evaluation factor satisfies a predetermined criterion and transmits the first control value to the artificial neural network, the gate circuit performs a logical operation on whether the second reference score calculated for each evaluation factor satisfies another predetermined criterion or whether the third reference score satisfies another predetermined criterion, and the second controller generates a second control value according to the logical operation result of the gate circuit to transmit the second control value to the artificial neural network.

10. A method of evaluating an attribute of a patent content, the method being performed by at least one processor and comprising:
receiving class information and an input score for a target patent content to be evaluated, wherein the class information comprises a code for specifying a technical field of the target patent content, and wherein the input score corresponds to each of evaluation factors included in a predetermined evaluation factor set;
selecting at least some evaluation factors among the evaluation factors included in the evaluation factor set, based on the class information;
calculating an attribute evaluation feature value of the target patent content using the input score for each of the evaluation factors and evaluation factor weights which are determined in advance to be different depending on the class information; and
providing a text or an image according to the attribute evaluation feature value of the target patent content to an user interface of a computing apparatus.

11. The method according to claim 10, wherein the calculating of the attribute evaluation feature value includes:
inputting the input score to an artificial neural network which is trained in advance to be differently determined according to the class information and the evaluation factor and
calculating an attribute evaluation feature value representing the attribute of the target patent content by the artificial neural network.

12. The method according to claim 10, wherein when the selecting of at least some of evaluation factors includes selecting at least some evaluation factors among the plurality of evaluation factors included in the predetermined evaluation factor set, based on a first reference score stored in a training data storage, and the first reference score is an information related to content validity of each evaluation factor for evaluating the attribute of the patent content and is received from a plurality of external computing apparatuses which is connected via a network.

13. The method according to claim 10, wherein in the selecting of at least some evaluation factors among the evaluation factors included in the predetermined evaluation factor set, based on the class information, one or more reference scores selected from a group consisting of the first reference score, a second reference score which represents a similarity between reference scores acquired for each evaluation factor at different timings from the same computing apparatus and is calculated by the processor, and third reference scores which represent a convergence attribute of the first reference scores acquired for each evaluation factor from the plurality of computing apparatus and are calculated by the processor are compared with a predetermined reference value and at least some evaluation factors among the plurality of evaluation factors included in the predetermined evaluation factor set are selected according to a comparison result.

14. The method according to claim 13, wherein the first reference score is related to the content validity of each evaluation factor and includes already acquired content validity ratio (CVR) information and the third reference score includes an agreement degree or a convergence degree related to the convergence attribute for each evaluation factor.

15. The method according to claim 13, wherein when a time-sequential deviation between attribute evaluation facture values of the patent contents belonging to the same class information satisfies a predetermined criterion, the artificial neural network further preforms the learning to update the connection weight and
when the attribute evaluation feature value of the target patent content is calculated, the connection weight is acquired through an updated artificial neural network.

16. A computer readable recording medium in which a program allowing a computer to perform the method of evaluating an attribute of a patent content according to anyone of claims 10 to 15 is recorded.
